(19) United States
(12) Patent Application Publication
(10) Pub. No.: US 2009/0044247 A1
(43) Pub. Date: Feb. 12, 2009

(54) Digital broadcasting receiving apparatus

(75) Inventor: Hiroaki Shibahara, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/222,435

(22) Filed: Aug. 8, 2008

(30) Foreign Application Priority Data
Aug. 10, 2007 (JP) 2007-208787

(51) Int. Cl. H04N 7/16

(52) U.S. Cl. 725/152

(57) ABSTRACT

A digital broadcasting receiving apparatus includes a decision portion for deciding whether or not broadcasting of a received channel is scrambled based on information about scrambling included in a header of a packet of the received channel, and a setting control portion for controlling to set the channel in a channel map to be capable of being selected by the channel up/down key if it is decided that broadcasting is not scrambled, and to set the channel in the channel map to be incapable of being selected by the channel up/down key if it is decided that broadcasting is scrambled.

This application is based on Japanese Patent Application No. 2007-208787 filed on Aug. 10, 2007, and the contents of which are hereby incorporated by reference.

### BACKGROUND OF THE INVENTION

1. Field of the Invention

The present invention relates to a digital broadcasting receiving apparatus such as a liquid crystal television set. In particular, the present invention can be applied effectively to a digital broadcasting receiving apparatus for receiving ATSC broadcasting.

2. Description of Related Art

At present, ground wave television broadcasting is in a transition period from analog broadcasting to digital broadcasting in Japan, so digital broadcasting receiving apparatuses capable of receiving digital broadcasting are becoming rapidly widespread.

Many of the digital broadcasting receiving apparatuses store a so-called channel map in a storage unit thereof, which is a list of channels that can be selected. This channel map is also used for selecting a channel by using a channel up/down key, and channels to be selected by the up/down key are displayed as a channel list that can be selected from a menu screen. What type of information is included in the channel map and when and how the channel map is generated are different depending on a manufacturer or each apparatus.

Therefore, a criterion about channels that can or cannot be selected by the channel up/down key is also different depending on a manufacturer or each apparatus. For instance, the following techniques are proposed.

JP-A-11-252472 discloses a tuning device of a multi-channel television receiver, in which a view contract is checked for each selected channel when a channel of a television receiver is selected by up/down tuning. If a selected channel is decided to be not included in the view contract, it is checked whether the broadcast program information data of the broadcast program transmitted by the channel contains a pay identification or charge data. If the pay identification or the charge data is not detected in the channel, the channel is decided to be a non-contract PPC (Pay Per Channel) and is excluded from the channels to be selected by the up/down tuning. Thus, reception and reproduction of a non-contract PPC channel can be avoided, and selection of an undesired channel in the up/down tuning can be avoided.

JP-A-5-168019 discloses a television receiving apparatus including a television tuner and a tuner control unit for supplying a tuning control signal to the television tuner. Based on a channel position increasing control (or decreasing control), the control unit generates a tuning control signal of a reception channel corresponding to a channel position higher than (or lower than) the present channel position by one and supplies the tuning control signal to the tuner for selection. Then, the control unit detects whether or not a reception signal obtained by the selection is in a scrambled state. If the reception signal is not in the scrambled state, the broadcasting of the reception channel is continued to receive. If the reception signal is the scrambled state, the control unit generates again the tuning control signal corresponding to a channel position higher than (or lower than) the present channel position by one and supplies the tuning control signal to the tuner for selection.

JP-A-2001-16524 discloses an automatic channel preset device, which scans every channel that is preset in a memory so as to decide whether or not a synchronizing signal exists in each channel. If the synchronizing signal does not exist, the channel is removed so that an unnecessary channel is automatically deleted.

There are digital broadcasting signals that are scrambled, and such scrambled broadcasting channels cannot be selected by the channel up/down key in the techniques described in the above patent documents. However, the techniques described in the above patent documents have complicated structures.

### SUMMARY OF THE INVENTION

It is an object of the present invention to provide a digital broadcasting receiving apparatus that can shorten channel switching time and realize a comfortable tuning operation by utilizing information delivered in digital broadcasting for deciding scrambled broadcasting easily, so that the channel cannot be selected by the channel up/down key.

A digital broadcasting receiving apparatus according to an embodiment of the present invention includes an operating unit having a channel up/down key for use of tuning operation, a storage unit for storing a channel map indicating whether or not each of channels can be selected by the channel up/down key, and a control unit for controlling the storage unit. The control unit decides whether or not broadcasting of a received channel is scrambled based on information about scrambling included in a header of a packet of the received channel. If it is decided that broadcasting is not scrambled, setting of the channel in the channel map is set to be capable of being selected by the channel up/down key. If it is decided that broadcasting is scrambled, the setting of the channel in the channel map is set to be incapable of being selected by the channel up/down key.

According to this structure, the information about scrambling included in the header of the packet is referred to for deciding whether or not the channel is scrambled. If it is not scrambled, the channel is set to be capable of being selected by the channel up/down key. If it is scrambled, the channel is set to be incapable of being selected by the channel up/down key. Thus, scrambled channels can be skipped when the channel up/down key is used for tuning.

### BRIEF DESCRIPTION OF THE DRAWINGS

FIG. 1 is a block diagram showing a structure of a digital broadcasting receiving apparatus according to the present invention.

FIG. 2 shows an example of a VCT.

FIG. 3 is a flowchart showing an action of a digital broadcasting receiving apparatus about registration in a channel map when automatic scan is performed according to the present invention.

FIG. 4 is a diagram showing an example of the channel map according to the present invention.

FIG. 5 is a flowchart showing an action of the digital broadcasting receiving apparatus about an automatic adding function according to the present invention.

FIG. 6 is a diagram showing an example of the channel map according to the present invention.

FIG. 7 is a diagram showing an example of the channel map according to the present invention.

FIG. 8 is a diagram showing an example of the channel map according to the present invention.

FIG. 9 is a flowchart showing an action of the digital broadcasting receiving apparatus about setting a channel list according to the present invention.

FIG. 10 is a diagram showing an example of a channel list frame according to the present invention.

### DETAILED DESCRIPTION OF THE PREFERRED EMBODIMENTS

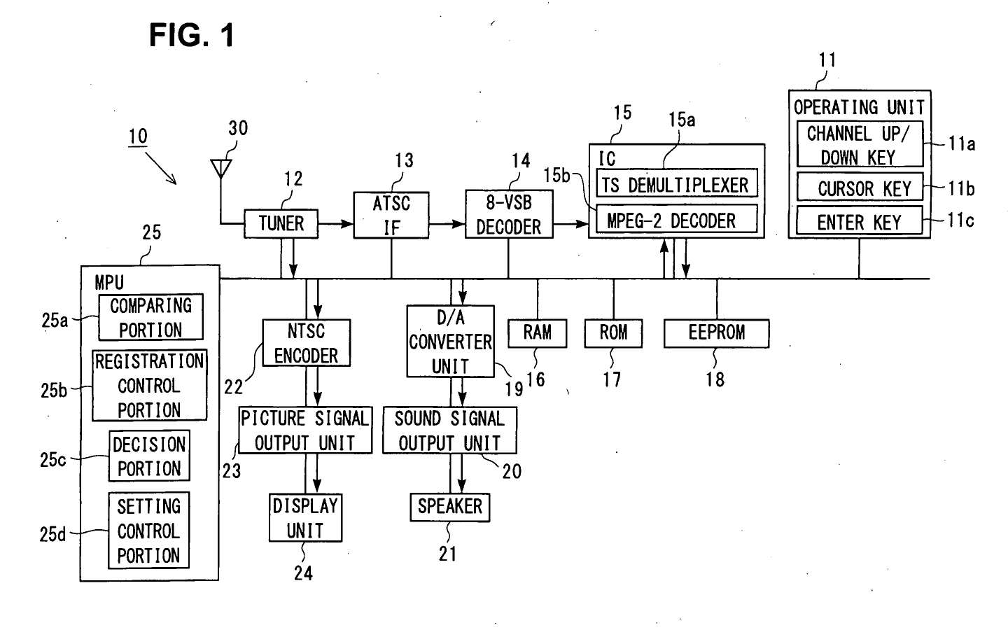

Hereinafter, a digital broadcasting receiving apparatus of an ATSC standard will be described as an example. FIG. 1 is a block diagram showing a structure of a digital broadcasting receiving apparatus 10. The digital broadcasting receiving apparatus 10 includes an operating unit 11, a tuner 12, an ATSC interface (hereinafter referred to as an ATSC IF) 13, an 8-VSB decoder 14, an IC 15, a RAM 16, a ROM 17, an EEPROM 18, a D/A converter unit 19, a sound signal output unit 20, a speaker 21, an NTSC encoder 22, a picture signal output unit 23, a display unit 24 and an MPU 25.

The operating unit 11 is made up of a plurality of keys for a user to perform various operations such as a tuning operation. One of the keys is a channel up/down key 11a, which includes a channel up key for selecting one by one channel in an ascending order of the channel number and a channel down key for selecting one by one channel in a descending order of the channel number. A tuning instruction by the channel up/down key 11a is based on contents of an item in a channel map that will be described later about that each channel is selected by the channel up/down key 11a (Add/Del item).

In addition, one of the keys of the operating unit 11 is a cursor key 11b for moving a cursor on a menu screen or the like so as to select individual items. The cursor key 11b is used for moving a cursor so as to select a desired channel on a channel list, for instance, which will be described later.

In addition, one of the keys of the operating unit 11 is an enter key 11c for determining the item selected by the cursor key 11b. The enter key 11c is used, for instance, for setting a desired channel to be selected or not to be selected by the channel up/down key 11a in the state where the channel is selected by the cursor on the channel list. Note that the operating unit 11 can be a remote controller using an infrared signal.

The tuner 12 is connected to an antenna 30 for receiving digital broadcasting waves, and the tuner 12 is used for selecting a desired channel among the digital broadcasting waves received by the antenna 30. The ATSC IF 13 is used for extracting a digital output wave from the tuner 12. The 8-VSB decoder 14 is used for decoding the digital output wave received from the ATSC IF 13 into data.

The IC 15 includes a TS demultiplexer 15a and an MPEG-2 decoder 15b. The TS demultiplexer 15a is used for demultiplexing the data decoded by the 8-VSB decoder 14 into individual types of data (VCT, EIT, picture data, sound data and the like). The MPEG-2 decoder 15b is used for decoding the data demultiplexed by the TS demultiplexer 15a into data before compression.

The RAM 16 is used for storing temporarily the data demultiplexed by the TS demultiplexer 15a. The ROM 17 is used for storing information necessary for operations of the digital broadcasting receiving apparatus 10. The EEPROM 18 is one of storage units and is used for storing the channel map and the channel list.

The channel map is a list of channels that can be selected in a form of association at least between a physical channel and an item about whether or not the channel can be selected by a virtual channel and by the channel up/down key 11a, which is generated by performing an automatic scan or an automatic adding function that will be described later. In contrast, the channel list is a frame for displaying an item about whether or not the channel can be selected by the channel up/down key 11a so that the item can be set, which is generated based on the channel map. The channel list can be displayed from the menu screen, so that the user can change the setting on the channel list about whether each channel can be selected or not. Contents of the setting changed on the channel list are reflected on the channel map.

The D/A converter unit 19 is used for converting the sound data output from the IC 15 into an analog signal. The sound signal output unit 20 is used for delivering the sound data converted into an analog data by the D/A converter unit 19. The speaker 21 is used for producing sounds based on a sound signal from the sound signal output unit 20.

The NTSC encoder 22 is used for decoding the picture data decoded by the MPEG-2 decoder 15b into an NTSC decoded television signal. The picture signal output unit 23 is used for delivering the NTSC decoded television signal decoded by the NTSC encoder 22. The display unit 24 is made up of a liquid crystal panel or the like, which is used for displaying pictures based on a picture signal from the picture signal output unit 23.

The MPU 25 is used for operations of the digital broadcasting receiving apparatus 10 and includes a comparing portion 25a, a registration control portion 25b, a decision portion 25c, a setting control portion 25d and the like. The comparing portion 25a is used for comparing virtual channel information of the received physical channel (here, a virtual channel number included in VCT (Virtual Channel Table)) with the channel map. The registration control portion 25b is used for controlling rewrite of channels registered in the channel map, and it controls so that an unregistered virtual channel is registered in the channel map, for instance.

The decision portion 25c is used for deciding whether or not the broadcasting is scrambled based on information about scrambling included in a header of a packet of the received channel (here, two-bit information such as “transport scrambling control” or “PES scrambling control” defined in an MPEG system standard). The setting control portion 25d is used for setting rewrite of contents of the item in the channel map (Add/Del item) about whether or not each channel can be selected by the channel up/down key 11a based on a result of the decision performed by the decision portion 25c. Hereinafter, setting that the channel cannot be selected (is skipped) by the channel up/down key 11a is referred to as ““Del setting””, and setting that the channel can be selected by the channel up/down key 11a is referred to as ““Add setting””.

Note that when the registration contents of the channel map is rewritten, the contents are reflected on the channel list, too.

Next, an operation when the digital broadcasting receiving apparatus 10 receives digital broadcasting will be described. First, the antenna 30 receives digital broadcasting waves. When tuning operation of the operating unit 11 is performed, the tuner 12 switches a transponder for reception. The received digital broadcasting wave is decoded into data by the 8-VSB decoder 14 via the ATSC IF 13.

Originally, the digital broadcasting wave is transmitted from the transmission side in a form of TS packets. The TS packet includes picture data, sound data, and control data including the VCT and the like. This control data is demultiplexed by the TS demultiplexer 15a of the IC 15 and is stored in the RAM 16. Then, the data read from the RAM 16 is decoded by the MPEG-2 decoder into data before compression. Next, the sound data is converted by the D/A converter unit 19 into an analog signal, which is supplied to the sound signal output unit 20 for the speaker 21 to produce sounds. In addition, the picture data is decoded by the NTSC encoder 22 into an NTSC decoded television signal, which is supplied to the picture signal output unit 23 for the display unit 24 to display pictures.

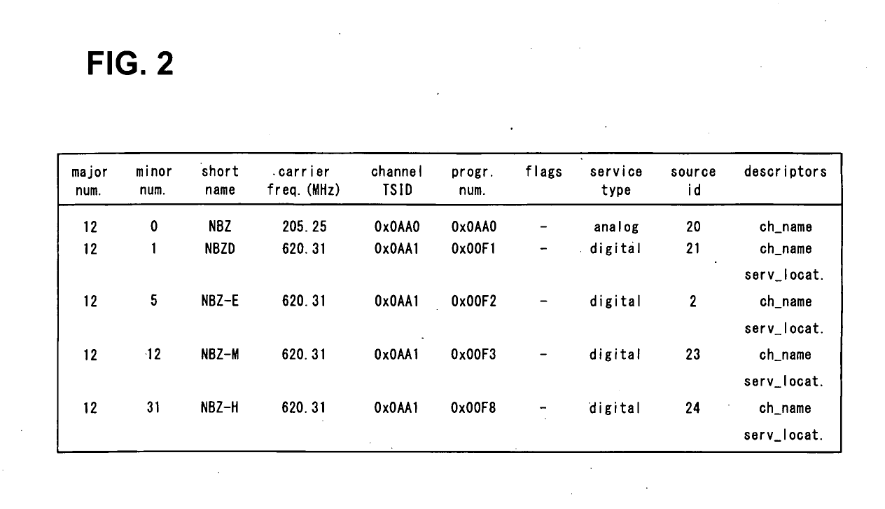

Then, the tuning operation by the user is performed by entering a virtual channel directly using the ten key (not shown) of the operating unit 11 or by operating the channel up/down key 11a. Here, the virtual channel includes a main channel and a sub channel. FIG. 2 shows an example of the VCT. The major number corresponds to the main channel while the minor number corresponds to the sub channel. In FIG. 2, the virtual channel having a minor number of “0” is analog broadcasting. Hereinafter, the main channel and the sub channel are separated by “−”. For instance, the case where the main channel is 12 and the sub channel is 34 is expressed as “12-34”.

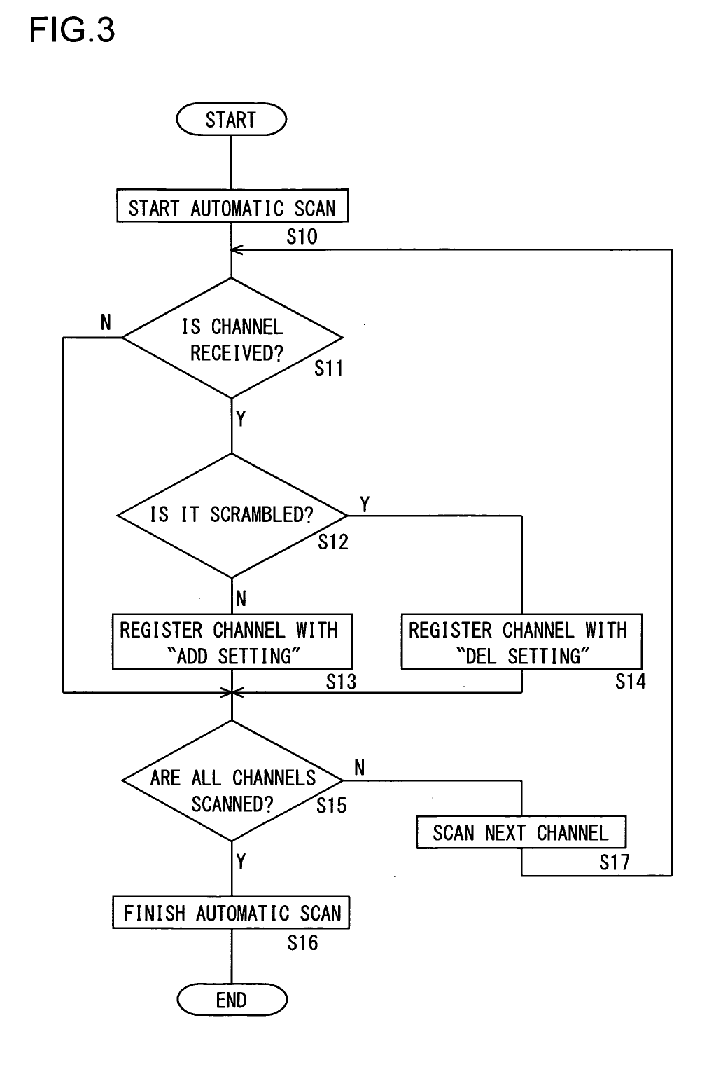

Next, a registration action of the channel map when the automatic scan is performed will be described. The automatic scan is a function of searching receivable channels automatically for registering receivable channels in the channel map, in which all the frequency bands are scanned in turn automatically so that receivable channels can be searched. FIG. 3 is a flowchart showing operations of the digital broadcasting receiving apparatus 10 about registration in the channel map when the automatic scan is performed.

First, when the operation of the operating unit 11 is performed so as to instruct to perform the automatic scan, the digital broadcasting receiving apparatus 10 starts the automatic scan in the step S10. Then, the process goes to the step S11, where it is decided whether or not the channel has been received. For instance, if the VCT has been obtained for a certain physical channel, the physical channel is decided to be capable of being received.

If the channel has not received in the step S11, the process goes to the step S15. On the contrary, if the channel has been received in the step S11, the process goes to the step S12. Then, based on information about scrambling included in the header of the packet of the received channel, it is decided whether or not broadcasting of the channel is scrambled. Here, the information about scrambling is two-bit information of “transport scrambling control” of TS defined in the MPEG system standard (ISO/IEC 13818-1) or the “PES scrambling control” of a PES (Packetized Elementary Stream), which can have a value of “00”, “01”, “10” or “11”.

In the “transport scrambling control” and the “PES scrambling control”, “00” indicates that the channel is not scrambled, and “01”, “10” and “11” can be defined by the broadcasting station. In the embodiment, therefore, “00” is decided to indicate that the channel is not scrambled, and “01”, “10” or “11” is decided to indicate that the channel is scrambled.

Whether or not the channel is scrambled should be decided by referring to only one of the “transport scrambling control” and the “PES scrambling control”. In addition, if both the “transport scrambling control” and the “PES scrambling control” are referred to and were found that at least one of them is “00”, it may be decided that the channel is not scrambled. Otherwise, i.e., both the values are “01”, “10” or “11”, it may be decided that the channel is not scrambled.

Although both the “transport scrambling control” and the “PES scrambling control” are delivered according to the standard, it is possible in the actual broadcasting that only one of them is delivered. Therefore, it is more secure to refer to both the “transport scrambling control” and the “PES scrambling control”.

In this way, it is decided in the step S12 whether or not the broadcasting is scrambled. If it is decided that the broadcasting is not scrambled, the process goes to the step S13, where the virtual channel is registered in association with the physical channel in the channel map while the Add/Del item is set to the “Add setting”.

On the contrary, if it is decided in the step S12 that the broadcasting is scrambled, the process goes to the step S14, where the virtual channel is registered in association with the physical channel in the channel map while the Add/Del item is set to the “Del setting”.

After the steps S13 and S14, the process goes to the step S15 where it is decided whether or not all the channels have been scanned. If it is decided in the step S15 that all the channels have been scanned, the process goes to the step S16 where the automatic scan is finished. On the contrary, if it is decided in the step S15 that all the channels have not been scanned, the process goes to the step S17 where the next channel is scanned so as to go back to the step S11 for continuing registration in the channel map.

According to this process, the channel that is set to the “Add setting” can be selected by the channel up/down key 11a while the channel that is set to the “Del setting” cannot be selected by the channel up/down key 11a.

For instance, if the physical channel “1” is selected by the automatic scan and the VCT thereof can be received, it is decided that the physical channel “1” is receivable. For instance, if the VCT includes virtual channels of “1-1”, “1-2” and “1-3”, values of the “transport scrambling control” and the “PES scrambling control” included in the header of the packet of each virtual channel is further referred to.

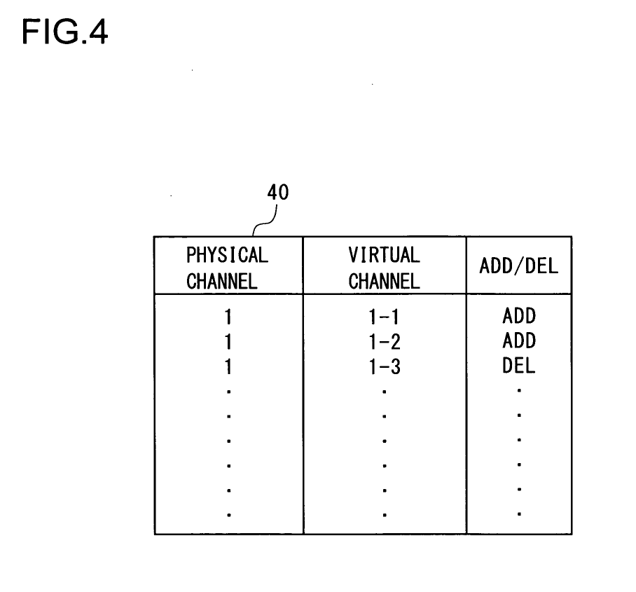

As a result, it is supposed that values of the “transport scrambling control” and the “PES scrambling control” of the channel “1-1” are both “00”, and that values of the “transport scrambling control” and the “PES scrambling control” of the channel “1-2” are both “00”, and that values of the “transport scrambling control” and the “PES scrambling control” of the channel “1-3” are both “01”. Then, as shown in FIG. 4, the virtual channel “1-1” is registered in association with the physical channel “1” in a channel map 40, and the Add/Del item thereof is set to the “Add setting”. After that, the virtual channel “1-2” is registered in association with the physical channel “1”, and the Add/Del item thereof is set to the “Add setting”. Then, the virtual channel “1-3” is registered in association with the physical channel “1”, and the Add/Del item thereof is set to the “Del setting”.

Thus, the virtual channel “1-1” and the “1-2” that have been set to the “Add setting” in the physical channel “1” can be selected by the channel up/down key 11a while the virtual channel “1-3” that has been set to the “Del setting” cannot be selected by the channel up/down key 11a.

In this way, the information about scrambling included in the header of the packet is referred to when the automatic scan is performed, so as to decide whether or not the channel is scrambled. If the channel is not scrambled, the Add/Del item of the channel map is set to the “Add setting”. If the channel is scrambled, the Add/Del item of the channel map is set to the “Del setting”. Thus, the scrambled channel can be skipped when the channel up/down key 11a is used for selecting channel. Therefore, time for switching channels can be shortened so that a comfortable tuning operation can be realized.

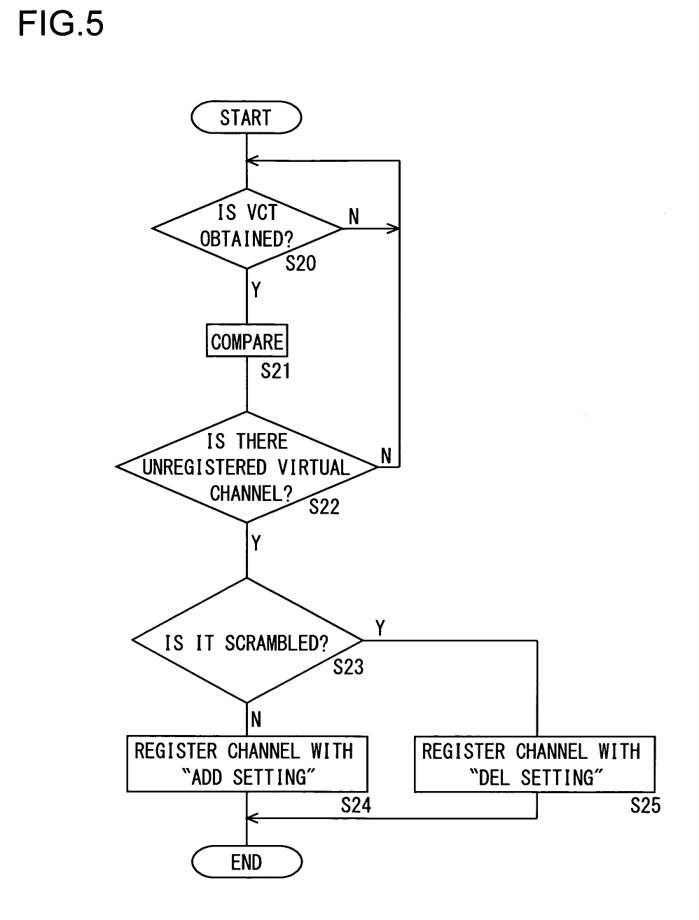

Next, the automatic adding function will be described, in which an unregistered new virtual channel is registered automatically in the channel map if the new channel is found when the normal tuning operation is performed. FIG. 5 is a flowchart showing an action of the digital broadcasting receiving apparatus 10 about the automatic adding function.

First, when the tuning operation is performed and the VCT of a physical channel is obtained by the MPU 25 in the step S20, the process goes to the step S21, where the comparing portion 25a compares the virtual channel number included in the VCT with the virtual channel number in the channel map. Then, the process goes to the step S22. If the VCT includes a virtual channel that is unregistered in the channel map, the process goes to the step S23 where it is decided whether or not the broadcasting of the channel is scrambled based on information about scrambling included in the header of the packet of the received channel. This decision method is as described above with reference to FIG. 3.

If it is decided in the step S23 that the channel is not scrambled, the process goes to the step S24 where the virtual channel is registered in the channel map in association with the physical channel, and the Add/Del item is set to the “Add setting”.

On the contrary, if it is decided in the step S23 that the channel is scrambled, the process goes to the step S25 where the virtual channel is registered in the channel map in association with the physical channel, and the Add/Del item is set to the “Del setting”.

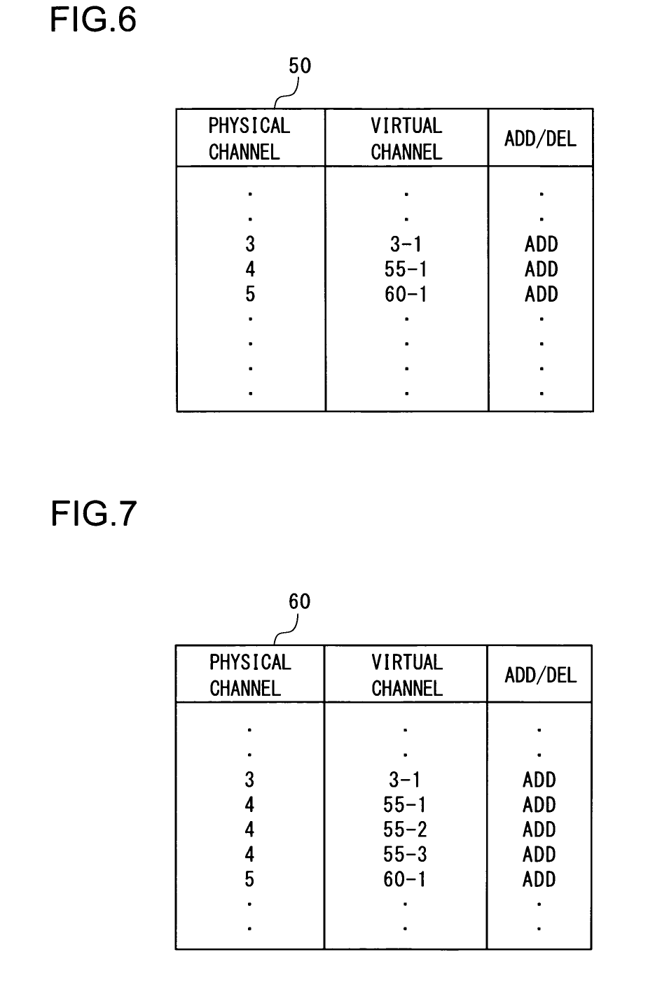

For instance, if the physical channel “4” is selected by the tuning operation while a certain channel is being received, the VCT of the physical channel “4” is received. On this occasion, it is supposed that only the virtual channel “55-1” corresponding to the physical channel “4” is registered in a current channel map 50 as shown in FIG. 6.

Then, the virtual channel number included in the VCT is extracted. It is supposed that the extracted virtual channel numbers is “55-1”, “55-2”, “55-3”, for instance. Then, each of these three virtual channel numbers is compared with the virtual channel corresponding to the physical channel “4” of the channel map 50 shown in FIG. 6. As a result of the comparison, it is found that the channel number “55-1” extracted from the VCT is already registered in the channel map 50, and that the channel numbers “55-2” and “55-3” extracted from the VCT are not registered yet in the channel map 50. Therefore, the channel numbers “55-2” and “55-3” that are not registered yet in the channel map 50 are registered additionally, so that the channel map 50 is updated to be a channel map 60 as shown in FIG. 7. On this occasion, it is supposed that it is decided that none of the virtual channels is scrambled.

As described above, if the physical channel “4” is selected, the broadcast program displayed on the display unit 24 at that time is “55-1” channel. The channel map 50 is updated to be the channel map 60 soon after that. Therefore, if the channel up key is operated in this state, the channels “55-2”, “55-3”, “60-1” and so on are selected in this order in accordance with the channel map 60.

In this way, only performing the normal tuning operation, an unregistered new channel, if there is in the channel map, can be registered automatically by the automatic adding function, so that the new channel can also be selected by the channel up/down key. Therefore, the user is not required to do a special operation for registering in the channel map or to be aware of registration in the channel map resulting in good usability.

Furthermore, when performing the registration, information about scrambling included in the header of the packet is also referred to, and it is decided whether or not the channel is scrambled. If it is not scrambled, the Add/Del item of the channel map is set to be the “Add setting”. If it is scrambled, the Add/Del item of the channel map is set to be the “Del setting”. Thus, the scrambled channel can be skipped when the channel up/down key 11a is used for tuning. Therefore, the channel switching time can be shortened so that a comfortable tuning operation can be realized.

Next, if there is a virtual channel number that is registered in the channel map but is not included in the received VCT, it may be left as it is. Alternatively, the corresponding virtual channel number may be deleted from the channel map. For instance, it is possible to consider the case where there is currently the channel map 50 shown in FIG. 6 while the received VCT includes the virtual channel numbers “55-2” and “55-3”.

If the product specification is “to be left as it is”, the channel number “55-1” is left as it is, so the channel map 50 is updated to be the channel map 60 shown in FIG. 7. According to this specification, the virtual channel number that has become receivable at least once is remained to be capable of being selected by the channel up/down key 11a anytime. However, some of the selected channels may not be broadcasted at present.

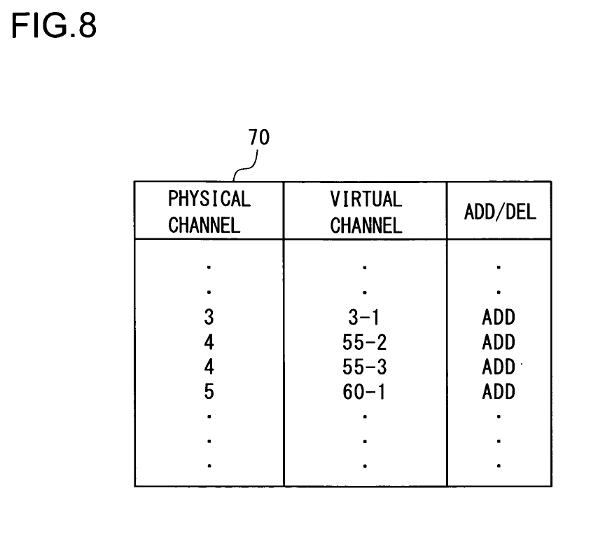

In contrast, if the product specification is “to remove”, the channel number “55-1” is removed, so the channel map 50 is updated to be a channel map 70 shown in FIG. 8. According to this specification, the virtual channel number that is not broadcasted at present is deleted from the channel map. Therefore, the virtual channel number that is not broadcasted at present cannot be selected when the channel up/down key 11a is used for tuning.

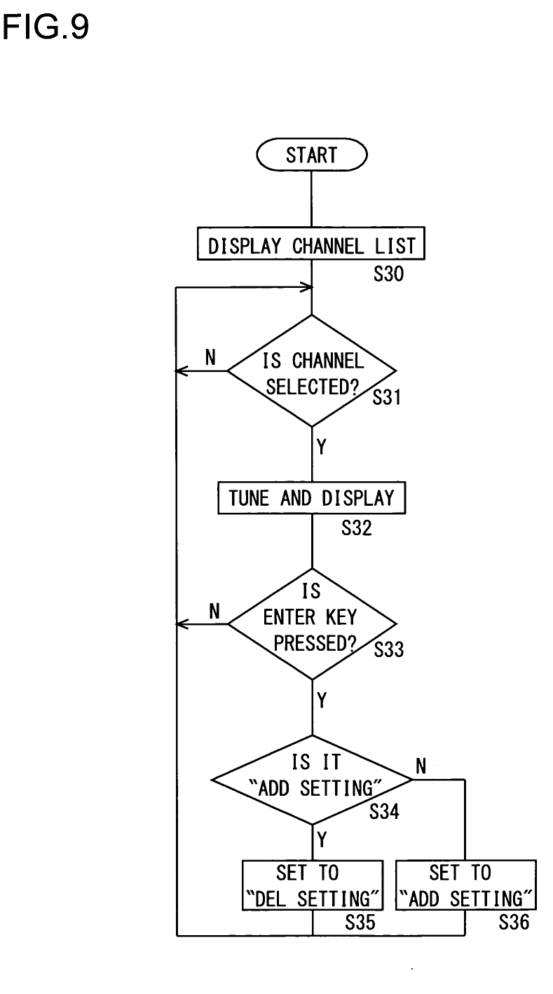

Next, the channel list will be described in detail. FIG. 9 is a flowchart showing an operation of the digital broadcasting receiving apparatus 10 about setting of the channel list.

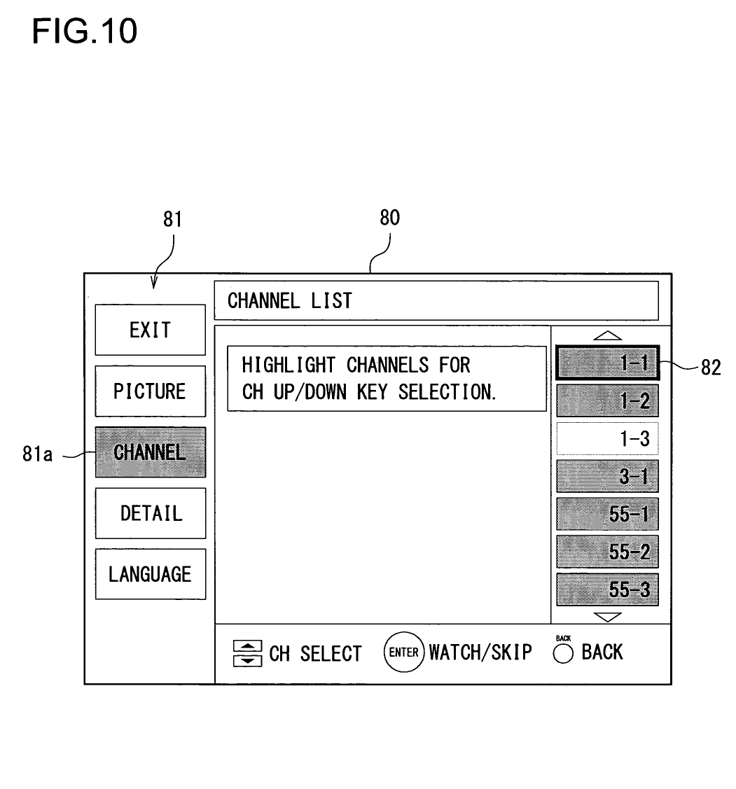

First, when the user operates the operating unit 11 for selecting and determining the item “CHANNEL” for displaying the channel list on the menu screen, the MPU 25 reads the channel list from the EEPROM 18 and makes the display unit 24 display the same in the step S30. FIG. 10 shows an example of a channel list frame 80. A menu 81 is displayed on the left side of the channel list frame 80, and one of items of the menu is a “CHANNEL” 81a. The “CHANNEL” 81a is highlighted in FIG. 10 so as to show that it is selected.

In addition, the virtual channels registered in the channel map are displayed on the right side of the channel list frame 80, and the virtual channels “1-1”, “1-2”, “3-1”, “55-1”, “55-2” and “55-3” are highlighted. The highlighted display indicates that the channels are in the “Add setting” state. In constant, the virtual channel “1-3” is displayed normally, which indicates that the channel is in the “Del setting” state.

In addition, the thick frame enclosing the channel “1-1” indicates a cursor 82. Delta symbols above the channel “1-1” and below the channel “55-3” indicate that other channels are displayed with scrolling if the cursor 82 is moved to each direction.

FIG. 9 is referred to again. When the channel list is displayed in the step S30, the process goes to the step S31 where it is decided whether or not any one of the channels in the channel list is selected. The selection of a channel is performed by operating the cursor key 11b to move the cursor 82 onto a desired channel.

If it is decided that any one of the channels in the channel list is selected in the step S31, the process goes to the step S22 where the selected channel is tuned and is displayed. The display should be performed in a size within a middle space of the screen. When the channel list frame is displayed at first, the cursor should be positioned on a default channel (e.g., the channel “1-1”), so that the channel is tuned and displayed.

Next in the step S33, it is decided whether or not the enter key 11c is pressed. Thus, the “Add setting” and the “Del setting” are switched by the operation of the enter key 11c. If it is decided that the enter key 11c is pressed in the step S33, the process goes to the step S34 where it is decided whether or not the currently selected channel is in the “Add setting” state. In contrast, if it is decided that the enter key 11c is not pressed in the step S33, the process goes back to the step S31.

If it is decided to be in the “Add setting” in the step S34, the process goes to the step S35 to switch to the “Del setting”. Then, the highlighted display of the channel is changed to the normal display. On the contrary, if it is decided not to be in the “Add setting” in the step S34, i.e., if it is decided to be in the “Del setting”, the process goes to the step S36 to switch to the “Add setting” so that the channel display is changed to be the highlighted display. For instance, it is possible to switch the channel that is decided to be scrambled by the automatic scan to be in the “Add setting”. The switching between the “Add setting” and the “Del setting” of the desired channel is finished in the step S35 or the step S36.

Then, the process goes back to the step S31 from the step S35 or the step S36. Note that if a back key (not shown) of the operating unit 11 is pressed during the process described above, the display can go back to the previous screen. If a cancel key (not shown) is pressed, the display of the channel list is finished so to go back to the menu screen. Then, the contents of change on the channel list are reflected on the channel map.

In this way, the switching between the “Add setting” and the “Del setting” of a desired channel can also be performed manually by utilizing the channel list.

Although the digital television or the like in which the digital broadcasting receiving apparatus 10 includes the speaker 21 and the display unit 24 is described in the above embodiment, the present invention can be applied to a set top box (STB) or a video apparatus, which is a tuner device without the speaker 21 and the display unit 24.

The digital broadcasting receiving apparatus of the present invention can be applied not only to the ATSC standard but also to other standard in which information about scrambling is included in a header of a packet.

The digital broadcasting receiving apparatus of the present invention can be used for a television receiving set such as a liquid crystal television, an STB as a tuner device, a video cassette recorder as a video apparatus, a DVD recorder, a hard disk recorder, a multifunction apparatus thereof, a mobile phone having a digital broadcasting receiver function, or the like.

What is claimed is:

1. A digital broadcasting receiving apparatus comprising:
an operating unit having a channel up/down key for use of tuning operation;
a storage unit for storing a channel map indicating whether or not each of channels can be selected by the channel up/down key; and
a control unit for controlling the storage unit, wherein
the control unit decides whether or not broadcasting of a received channel is scrambled based on information about scrambling included in a header of a packet of the received channel,
if it is decided that broadcasting is not scrambled, setting of the channel in the channel map is set to be capable of being selected by the channel up/down key, and
if it is decided that broadcasting is scrambled, the setting of the channel in the channel map is set to be incapable of being selected by the channel up/down key.

2. The digital broadcasting receiving apparatus according to claim 1, wherein
when an automatic scan is performed for registering receivable channels in the channel map, the control unit decides whether or not broadcasting of a received channel is scrambled based on information about scrambling included in a header of a packet of the received channel,
if it is decided that broadcasting is not scrambled, setting of the channel in the channel map is set to be capable of being selected by the channel up/down key, and
if it is decided that broadcasting is scrambled, the setting of the channel in the channel map is set to be incapable of being selected by the channel up/down key.

3. The digital broadcasting receiving apparatus according to claim 1, wherein the control unit includes
a decision portion for deciding whether or not broadcasting of a received channel is scrambled based on information about scrambling included in a header of a packet of the received channel, and
a setting control portion for controlling to set the channel in the channel map to be capable of being selected by the channel up/down key if it is decided that broadcasting is not scrambled, and to set the channel in the channel map to be incapable of being selected by the channel up/down key if it is decided that broadcasting is scrambled.

4. The digital broadcasting receiving apparatus according to claim 1, wherein
the information about scrambling is two-bit information of “transport scrambling control” defined in an MPEG system standard,
if the information is “00”, the control unit decides that the broadcasting is not scrambled, and
if the information is “01”, “10” or “11”, the control unit decides that the broadcasting is scrambled.

5. The digital broadcasting receiving apparatus according to claim 1, wherein
the information about scrambling is two-bit information of “PES scrambling control” defined in an MPEG system standard,
if the information is “00”, the control unit decides that the broadcasting is not scrambled, and
if the information is “01”, “10” or “11”, the control unit decides that the broadcasting is scrambled.

6. The digital broadcasting receiving apparatus according to claim 1, wherein
the information about scrambling is two-bit information of “transport scrambling control” and “PES scrambling control” defined in an MPEG system standard,
if at least one of them is “00”, the control unit decides that the broadcasting is not scrambled, and
otherwise, the control unit decides that the broadcasting is scrambled.

7. The digital broadcasting receiving apparatus according to claim 1, wherein ATSC (Advanced Television System Committee) broadcasting is received.

8. The digital broadcasting receiving apparatus according to claim 1, wherein the control unit is an MPU, the storage unit is an EEPROM, and the apparatus further includes a display unit for displaying received pictures and a speaker for producing received sounds.
